(19) United States
(12) Patent Application Publication
(10) Pub. No.: US 2025/0364582 A1
(43) Pub. Date: Nov. 27, 2025

(54) BATTERY CELL REVERSAL DEVICE

(71) Applicants: Hyundai Motor Company, Seoul (KR); Kia Corporation, Seoul (KR)

(72) Inventors: Jongmin PARK, Hwaseong-si (KR); Ryuhwan JUNG, Hwaseong-Si (KR); Young Seok LEE, Hwaseong-Si (KR); Seung Yeop LEE, Hwaseong-SI (KR)

(73) Assignees: Hyundai Motor Company, Seoul (KR); Kia Corporation, Seoul (KR)

(21) Appl. No.: 18/952,809

(22) Filed: Nov. 19, 2024

(30) Foreign Application Priority Data
May 22, 2024 (KR) 10-2024-0066436

(51) Int. Cl. H01M 10/04

(52) U.S. Cl. CPC H01M 10/0409

(57) ABSTRACT

A battery cell reversal device for reversing a plurality of battery cells forming an electrode assembly includes a pitch conveyor on which the plurality of battery cells are accommodated and configured to extend in one direction and operate the plurality of battery cells to move, a cell reversing unit configured to reverse a battery cell selected from the pitch conveyor, a loading orthogonal robot configured to discharge the selected battery cell from the pitch conveyor to the cell reversing unit, and an unloading orthogonal robot configured to return the battery cell on which reversal has been completed by the cell reversing unit to the pitch conveyor.

### CROSS-REFERENCE TO RELATED APPLICATION

The present application claims priority to Korean Patent Application No. 10-2024-0066436 filed on May 22, 2024, the entire contents of which is incorporated herein for all purposes by this reference.

### BACKGROUND OF THE PRESENT DISCLOSURE

### Field of the Present Disclosure

The present disclosure relates to a battery cell reversal device, and more particularly, to a battery cell reversal device reversing a battery in a vertical direction and rotating the battery in a horizontal direction during a process of modularizing the battery or an electrode assembly.

### Description of Related Art

In general, electrode assemblies may be classified into a jelly roll type electrode assembly wound with a separator located between a cathode plate and an anode plate, a stack type electrode assembly in which battery cells with a separator located between a cathode plate and an anode plate are sequentially stacked, etc. The stack type electrode assembly is mainly used for a pouch type battery, and the jelly roll type electrode assembly is mainly used for a can type secondary battery.

The stack type electrode assembly has a structure in which multiple anode and cathode unit cells are sequentially stacked, and has advantages of a high energy density per weight and being easy to obtain a prismatic shape. A stack type battery has a structure in which a cathode lead connecting one or more cathode plates to each other and connecting the cathode plates to the outside of the battery, and an anode lead connecting one or more anode plates to each other and connecting the anode plates to the outside of the battery are connected to a power source outside a battery packaging material.

In most battery designs, opposite leads are off-set against each other so as not to contact with each other. However, when the outermost electrode of a battery of a stack structure is a cathode during a manufacturing process or during using a product, a short circuit may occur due to a physical contact between the outermost cathode and an anode lead.

Therefore, it is necessary to develop a battery cell reversal device capable of preventing a physical contact between the outermost anode and a cathode lead when the outermost electrode of the battery of the stack structure is an anode during the manufacturing process or when using the product.

As shown in FIG. 1, the battery cell reversal device of the related art performs a cell width reversal process A and horizontal direction reversal processes B and C, and the horizontal direction reversal processes B and C include the odd cell (first and third cells) reversal process B and the even cell (second and fourth cells) reversal process C. Here, illustration of the fourth cell 4 is omitted. At the instant time, in the cell width reversal process A, the first to fourth cells are reversed in a front and rear direction in the drawings, that is, in a width direction, in the first horizontal direction reversal process B, the first and third cells are reversed in a vertical direction in the drawings, that is, in a horizontal direction, and in the second horizontal direction reversal process C, the second and fourth cells are reversed in the vertical direction in the drawings, that is, in the horizontal direction thereof.

The reversal process may be variously performed according to a cell combination, and accordingly, it is possible to produce battery modules of various specifications. Reversed battery cells are assembled (stacked) in a 2 cell unit in accordance with a battery module type in a cell assembly line.

However, the battery cell reversal device of the related art is divided into the three processes (A, B, and C processes), occupies a large process line area, and includes a complicated control program. Furthermore, the battery cell reversal device of the related art is a pitch conveyor method, which moves in a 4 cell unit, which has a problem in that an operation of the entire line is hindered even if only one problem occurs in a plurality of processes.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a battery cell reversal device configured for reducing a line area and reducing management points by integrating three battery cell reversal processes into one process.

A battery cell reversal device for reversing a plurality of battery cells forming an electrode assembly according to an exemplary embodiment of the present disclosure includes a pitch conveyor on which the plurality of battery cells are accommodated and configured to extend in one direction and operate the plurality of battery cells to move, a cell reversing unit configured to reverse a battery cell selected from the pitch conveyor, a loading orthogonal robot configured to discharge the selected battery cell from the pitch conveyor to the cell reversing unit, and an unloading orthogonal robot configured to return the battery cell on which reversal has been completed by the cell reversing unit to the pitch conveyor.

The plurality of battery cells may include four battery cells in a bundle.

The cell reversing unit may allow the battery cell on which the reversal has been completed to move one pitch by a moving orthogonal robot in a moving direction of the pitch conveyor.

The cell reversing unit may move along a linear motion (LM) guide extending in a direction parallel to a longitudinal direction of the moving orthogonal robot.

The cell reversing unit may include a cell support pad on which the plurality of battery cells discharged from the pitch conveyor are accommodated, cell clamp chuck cylinders configured to clamp the plurality of battery cells at an upper portion of the cell support pad, and cell reversing rotary cylinders configured to rotate to reverse the clamped battery cells.

The cell support pad may be supported by a reciprocating cell support pad ascending and descending guide cylinder and operate to ascend or descend with respect to the cell clamp chuck cylinders.

The cell support pad may ascend by the cell support pad ascending and descending guide cylinder so that the battery cells discharged by the loading orthogonal robot is accommodated thereon, and when the cell clamp chuck cylinder clamps the battery cells, descend again by the cell support pad ascending and descending guide cylinder.

The cell support pad may include blocks divided into four zones, and the blocks may include four battery cells to be respectively accommodated thereon.

The cell clamp chuck cylinders may be provided in four sets on an upper portion of the cell support pad to respectively correspond to the blocks.

A set of cell clamp chuck cylinders may be provided as a pair fixed to an inside of a cell clamp chuck cylinder fixing member and facing each other.

The set of cell clamp chuck cylinders may operate to clamp upper end portions and lower end portions of the battery cells and rotate together inside the cell clamp chuck cylinder fixing member to reverse the battery cells in a horizontal direction thereof.

The cell reversing rotary cylinders may be provided to face each other outside of the cell clamp chuck cylinder fixing member and operate to rotate while supporting the cell clamp chuck cylinder fixing member.

The cell reversing rotary cylinders may be configured to reverse the battery cells clamped on the cell clamp chuck cylinders in a vertical direction by rotating the cell clamp chuck cylinder fixing member.

The selected battery cell may be reversed by the cell reversing unit and simultaneously move one pitch in a longitudinal direction of the pitch conveyor, and the battery cell which is not selected may move one pitch on the pitch conveyor in the longitudinal direction of the pitch conveyor.

The battery cell on which reversal has been completed by the cell reversing unit may be returned to side of the battery cell which is not selected on the pitch conveyor by the unloading orthogonal robot and be aligned.

According to an exemplary embodiment of the present disclosure, an installation area and an investment cost of a device may be reduced by integrating three existing battery cell reversal processes into one process.

Furthermore, when a problem occurs in a portion of a pitch conveyor due to a structure of the pitch conveyor, while the entire line needs to be stopped, management points may be reduced due to a process reduction.

Furthermore, a fully flexible facility that only requires an addition of a program is implemented without adding a separate instrument portion, and a multi-variety hybrid production is possible in one line.

Furthermore, the number of direct contacts with a battery cell is reduced, and thus, damage to the battery cell may be reduced, and a stable reversal is possible.

Furthermore, all projects may be deployed horizontally regardless of the type and size of a battery cell, and as a standardized facility in a battery cell assembly line, it is possible to reduce costs of specification review, design, and manufacturing.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a diagram schematically illustrating the battery cell reversal process of the related art.

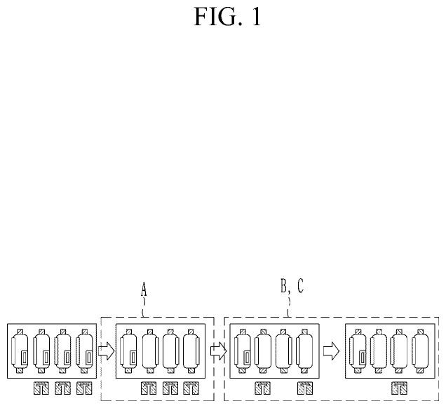

FIG. 2 is a conceptual diagram schematically illustrating a battery cell reversal device according to an exemplary embodiment of the present disclosure.

FIG. 3 is a side view exemplarily illustrating a battery cell reversal device according to an exemplary embodiment of the present disclosure.

FIG. 4 is a front view exemplarily illustrating a battery cell reversal device according to an exemplary embodiment of the present disclosure.

FIG. 5 is a perspective view exemplarily illustrating a cell reversing unit of a battery cell reversal device according to an exemplary embodiment of the present disclosure.

FIG. 6 is another perspective view exemplarily illustrating a cell reversing unit of a battery cell reversal device according to an exemplary embodiment of the present disclosure.

FIG. 7 is a side view exemplarily illustrating a cell reversing unit of a battery cell reversal device according to an exemplary embodiment of the present disclosure.

FIG. 8 is a front view exemplarily illustrating a cell reversing unit of a battery cell reversal device according to an exemplary embodiment of the present disclosure.

FIG. 9 is a view exemplarily illustrating a battery cell for describing an operation mechanism of a battery cell reversal device according to an exemplary embodiment of the present disclosure.

FIG. 10 is a flowchart illustrating an operation mechanism of a battery cell reversal device according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

The present disclosure will be described more fully hereinafter with reference to the accompanying drawings, so that those skilled in the art to which the present disclosure pertains may easily implement the exemplary embodiments of the present disclosure. However, the present disclosure may be implemented in many different forms and is not limited to the exemplary embodiments described herein.

Furthermore, in various exemplary embodiments of the present disclosure, elements including the same configuration are typically described in an exemplary embodiment of the present disclosure by use of the same reference numerals, and in other exemplary embodiments of the present disclosure, only configurations different from an exemplary embodiment will be described.

Please be informed that the drawings are schematic and not drawn to scale.

Relative dimensions and ratios of parts in the drawings are shown exaggerated or reduced in size for clarity and convenience in the drawings, and any dimensions are illustrative only and not limiting. Furthermore, the same reference numerals are used to denote similar features in the same structure, element or parts appearing in two or more drawings. When an element is referred to as being “on” another element, it may be directly on the other element or intervening elements may also be accompanied.

The exemplary embodiment of the present disclosure specifically represents an exemplary embodiment of the present disclosure. As a result, various modifications of diagrams are expected. Therefore, the exemplary embodiment of the present disclosure is not limited to a specific shape of an area shown, and includes, for example, a modification of the shape by manufacturing.

Hereinafter, a battery cell reversal device according to an exemplary embodiment of the present disclosure will be described in detail with reference to the accompanying drawings.

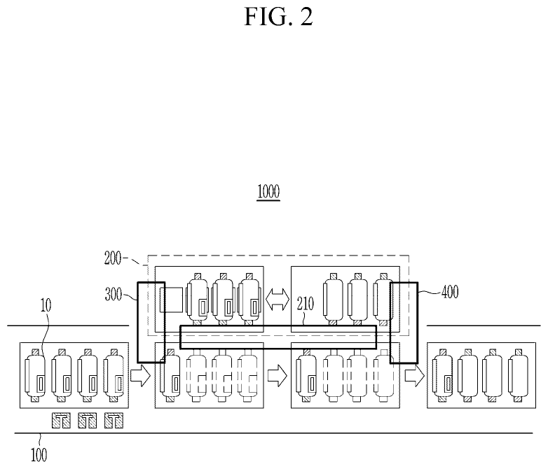

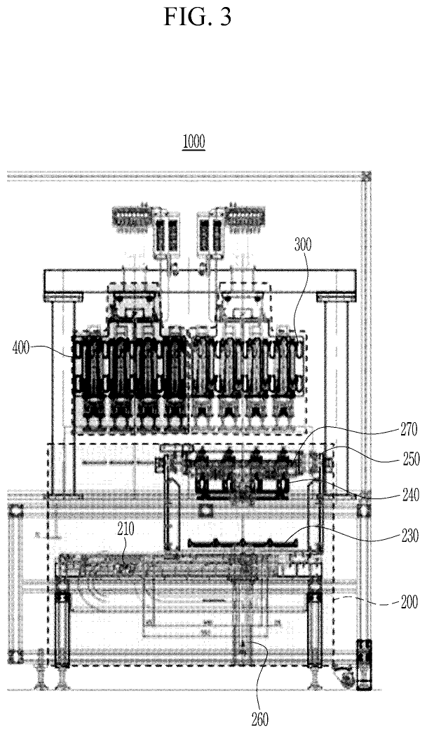

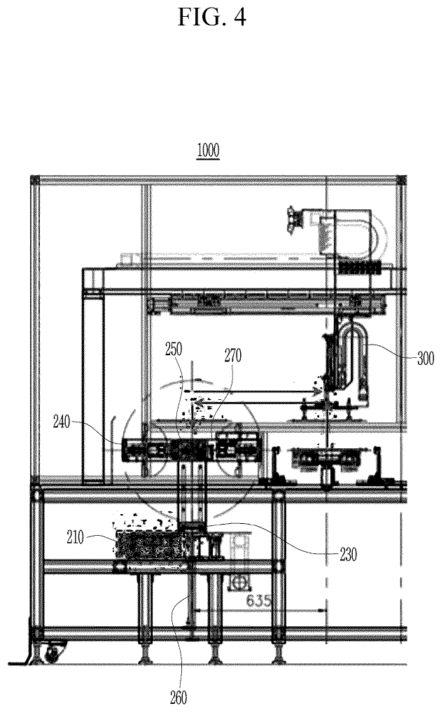

FIG. 2 is a conceptual diagram schematically illustrating a battery cell reversal device according to an exemplary embodiment of the present disclosure. FIG. 3 is a side view exemplarily illustrating the battery cell reversal device according to an exemplary embodiment of the present disclosure. FIG. 4 is a front view exemplarily illustrating the battery cell reversal device according to an exemplary embodiment of the present disclosure.

Referring to FIG. 2, and FIG. 3, the battery cell reversal device according to an exemplary embodiment of the present disclosure is a device 1000 for reversing a plurality of battery cells 10 forming an electrode assembly, and includes a pitch conveyor 100, a cell reversing unit 200, a loading orthogonal robot 300, and an unloading orthogonal robot 400.

The pitch conveyor 100 on which the battery cell 10 is accommodated moves and extends in one direction to operate so that the battery cell 10 moves. Four battery cells 10 move together as a unit, and the battery cell 10 requiring reversal may be selectively extracted and discharged. The battery cell 10 selected from the pitch conveyor 100 may be reversed by the cell reversing unit 200.

The loading orthogonal robot 300 may selectively discharge the battery cell 10 requiring reversal from the pitch conveyor 100. The loading orthogonal robot 300 individually picks up the battery cell 10 requiring reversal in units of the four battery cells 10 and transmits the battery cell 10 to the cell reversing unit 200.

The unloading orthogonal robot 400 returns the battery cell 10 on which reversal is completed by the cell inversion unit 200 to the pitch conveyor 100. The battery cell 10 on which reversal has been completed is not reversed and is returned to the side of the battery cell 10 moved on the pitch conveyor 100 to be aligned side by side.

Referring to FIG. 2, the four battery cells 10 move on the pitch conveyor 100 in one direction, and the loading orthogonal robot 300 picks the battery cell 10 requiring reversal and discharges the battery cell 10 to the cell reversing unit 200.

The battery cell 10 which is not discharged to the cell reversing unit 200 moves one pitch on the pitch conveyor 100, and the battery cell 10 discharged to the cell reversing unit 200 is reversed and simultaneously moves one pitch. The movement of the battery cell 10 discharged to the cell reversing unit 200 may be performed by a moving orthogonal robot 210 disposed at a lower portion of the cell reversing unit 200. The moving orthogonal robot 210 may support the cell reversing unit 200 at a lower portion and move the cell reversing unit 200 by one pitch.

The unloading orthogonal robot 400 may pick the battery cell 10 on which reversal has been completed by the cell reversing unit 200 and return the battery cell 10 to the pitch conveyor 100. The battery cell 10 returned to the pitch conveyor 100 is not reversed but returned to the side of the battery cell 10 moved on the pitch conveyor 100 and aligned side by side.

Thereafter, the cell reversing unit 200 is returned to its original position by the moving orthogonal robot 210, and the above process is performed on a new bundle of battery cells 10 transferred from the pitch conveyor 100.

Referring to FIG. 3 and FIG. 4, the battery cell reversal device 1000 may be configured in a form in which the loading orthogonal robot 300 and the unloading orthogonal robot 400 are sequentially disposed on an upper portion of the cell reversing unit 200, and the moving orthogonal robot 210 is disposed in the lower portion of the cell reversing unit 200.

The battery cells 10 in which four battery cells are configured as a bundle and placed on a cell support pad 230 moves on the pitch conveyor 100. The cell support pad 230 may be supported by a cell support pad ascending and descending guide cylinder 260 to ascend and descend.

When the battery cell 10 moves on the pitch conveyor 100 and is located at a lower portion of the loading orthogonal robot 300, the cell support pad 230 ascends by the cell support pad ascending and descending guide cylinder 260, and the battery cell 10 requiring reversal is picked by the loading orthogonal robot 300. Thereafter, the cell support pad 230 descends by the cell support pad ascending and descending guide cylinder 260, and the picked battery cell 10 is discharged to the cell reversing unit 200.

The battery cell 10 on the descended cell support pad 230 moves one pitch along the pitch conveyor 100, the battery cell 10 discharged to the cell reversing unit 200 is reversed by the cell reversing unit 200, and then moves one pitch equal to a pitch moving distance of the descended cell support pad 230 by the moving orthogonal robot 210.

After the battery cells 10 move by one pitch, when the cell reversing unit 200 is located at a lower portion of the unloading orthogonal robot 400, the battery cell 10 on which reversal has been completed is picked by the unloading orthogonal robot 400. The cell support pad 230 ascends by the cell support pad ascending and descending guide cylinder 260, the picked battery cell 10 on which reversal has been completed is accommodated on the cell support pad 230, and returned to the side of the battery cell 10 moved on the pitch conveyor 100 without being reversed and aligned side by side. Thereafter, the cell support pad 230 descends so that the battery cells 10 are returned to the pitch conveyor 100.

Furthermore, the cell reversing unit 200 is returned to its original position by the moving orthogonal robot 210.

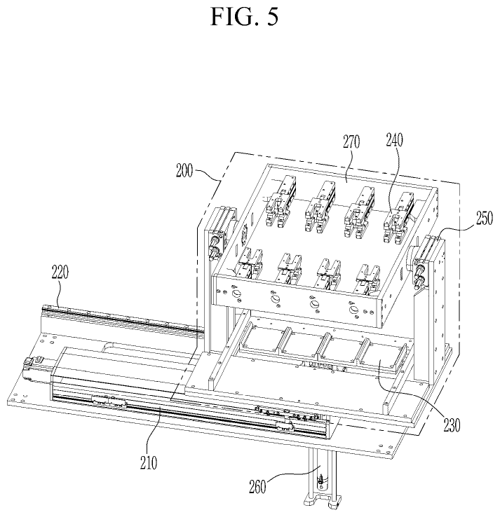

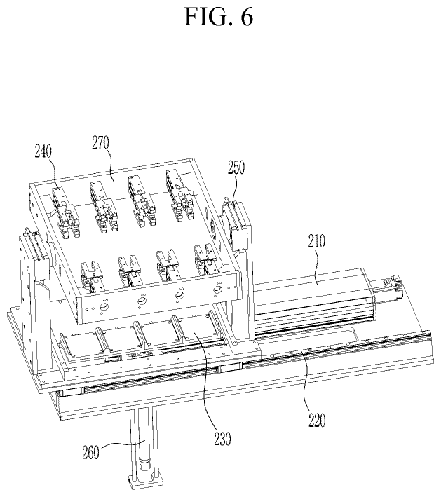

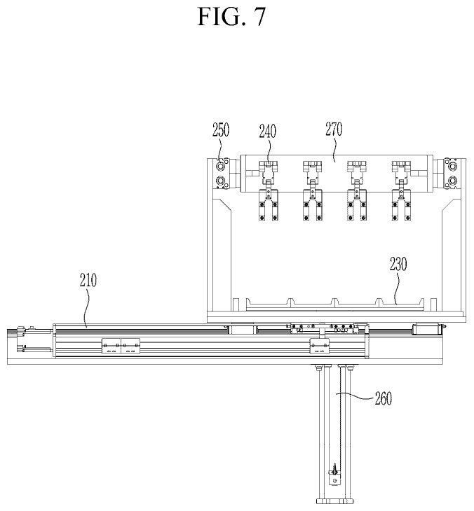

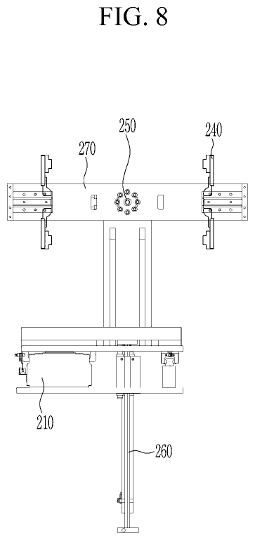

FIG. 5 is a perspective view exemplarily illustrating the cell reversing unit of the battery cell reversal device according to an exemplary embodiment of the present disclosure. FIG. 6 is another perspective view exemplarily illustrating the cell reversing unit of the battery cell reversal device according to an exemplary embodiment of the present disclosure. FIG. 7 is a side view exemplarily illustrating the cell reversing unit of the battery cell reversal device according to an exemplary embodiment of the present disclosure. FIG. 8 is a front view exemplarily illustrating the cell reversing unit of the battery cell reversal device according to an exemplary embodiment of the present disclosure.

Referring to FIGS. 5 to 8, the cell reversing unit 200 of the battery cell reversal device 1000 according to an exemplary embodiment of the present disclosure includes a structure of being moved by one pitch by the moving orthogonal robot 210 in a moving direction of the pitch conveyor 100, and may move along a linear motion (LM) guide 220 extending in a direction parallel to a longitudinal direction of the moving orthogonal robot 210.

The cell reversing unit 200 includes the cell support pad 230, cell clamp chuck cylinders 240, and cell reversing rotary cylinders 250.

The battery cells 10 discharged from the pitch conveyor 100 may be accommodated on the cell support pad 230. The cell support pad 230 may include blocks divided into four zones so that the four battery cells 10 configured in a bundle may be accommodated respectively.

A lower portion of the cell support pad 230 may be supported by the cell support pad ascending and descending guide cylinder 260 to ascend or descend according to the ascending and descending of the cell support pad ascending and descending guide cylinder 260.

The battery cells 10 ascending by the cell support pad ascending and descending guide cylinder 260 and discharged by the loading orthogonal robot 300 may be accommodated on the cell support pad 230. When the cell clamp chuck cylinders 240 clamp the battery cells 10, the battery cells 10 may operate to descend again by the cell support pad ascending and descending guide cylinder 260.

The cell clamp chuck cylinders 240 may be provided to clamp the battery cells 10 on an upper portion of the cell support pad 230. The cell clamp chuck cylinders 240 may be provided in four sets on the upper portion of the cell support pad 230 to correspond to the respective blocks of the cell support pad 230. Furthermore, a pair of cell clamp chuck cylinders 240 fixed to an inside the of a cell clamp chuck cylinder fixing member 270 and facing each other may be provided as a set.

The set of cell clamp chuck cylinders 240 may operate to clamp upper end portions and lower end portions of the battery cells 10 and rotate together in the same direction inside the cell clamp chuck cylinder fixing member 270 to reverse the battery cells 10 in a horizontal direction thereof. The cell clamp chuck cylinder fixing member 270 may be formed in a square loop shape including an internal wall and an external wall.

The cell reversing rotary cylinders 250 may be provided to face each other outside of the cell clamp chuck cylinder fixing member 270 and operate to rotate while supporting the cell clamp chuck cylinder fixing member 270.

The cell reversing rotary cylinders 250 may reverse the battery cells 10 clamped on the cell clamp chuck cylinders 240 in a vertical direction by rotating the cell clamp chuck cylinder fixing member 270.

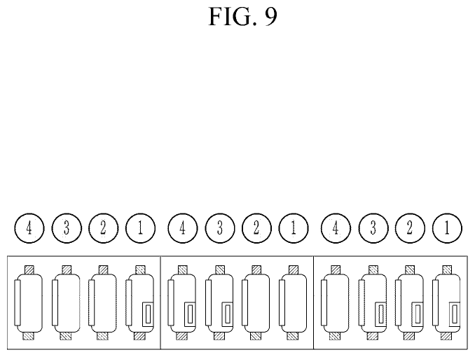

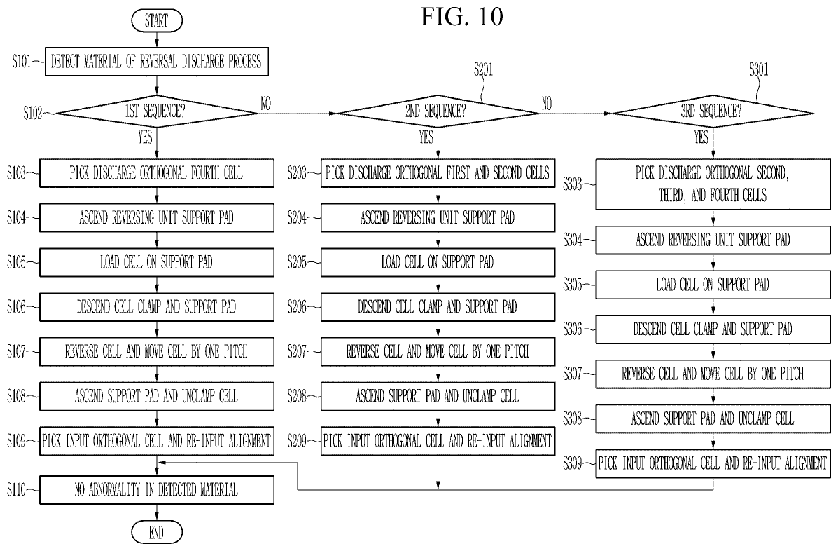

FIG. 9 is a view exemplarily illustrating a battery cell for describing an operation mechanism of the battery cell reversal device according to an exemplary embodiment of the present disclosure. FIG. 10 is a flowchart illustrating an operation mechanism of the battery cell reversal device according to an exemplary embodiment of the present disclosure.

Referring to FIG. 9 and FIG. 10, the operation mechanism of the battery cell reversal device 1000 including a controller according to an exemplary embodiment of the present disclosure first detects a material of a reversal discharge process (S101) and determines which sequence of battery cell reversal is required (S102, S201, and S301).

The sequence of battery cells is determined by the state of four battery cells in a set. For example, in FIG. 9, a battery cell sequence of the rightmost set is a first sequence, a battery cell sequence of a middle set is a second sequence, and a battery cell sequence of the leftmost set is a third sequence.

When it is determined that battery cell sequences of a first set are required (S102), the loading orthogonal robot 300 picks a fourth battery cell of the first sequence (S103), and the cell support pad 230 of the cell reversing unit 200 ascends (S104). The fourth battery cell is loaded on the cell support pad 230 (S105), the cell clamp chuck cylinder 240 picks the fourth battery cell, and the cell support pad 230 descends (S106).

The fourth battery cell is reversed by rotating in a horizontal direction by the rotation of the cell clamp chuck cylinder 240, is reversed by rotating in a vertical direction by the rotation of the cell inversion rotary cylinder 250, and simultaneously, the cell reversing unit 200 moves by one pitch by the moving orthogonal robot 210 (S107). The cell support pad 230 ascends, and the cell clamp chuck cylinder 240 releases the picking of the fourth battery cell to load the fourth battery cell on the cell support pad 230 (S108).

Thereafter, the fourth battery cell is picked by the unloading orthogonal robot 400 and returned to the side of first, second, and third battery cells (S109), the material is detected, is inspected whether there is any abnormality (S110), and when there is no abnormality, a reversal process ends.

On the other hand, when it is determined that battery cell sequences of a second set are required (S201), the loading orthogonal robot 300 picks first and second battery cells of the second sequence (S203), and the cell support pad 230 of the cell reversing unit 200 ascends (S204). The first and second battery cells are loaded on the cell support pad 230 (S205), the cell clamp chuck cylinder 240 picks the first and second battery cells, and the cell support pad 230 descends (S206).

The first and second battery cells reversed by rotating in the horizontal direction by the rotation of the cell clamp chuck cylinder 240, are reversed by rotating in the vertical direction by the rotation of the cell inversion rotary cylinder 250, and simultaneously, the cell reversing unit 200 moves by one pitch by the moving orthogonal robot 210 (S207). The cell support pad 230 ascends, and the cell clamp chuck cylinder 240 releases the picking of the first and second battery cells to load the first and second battery cells on the cell support pad 230 (S208).

Thereafter, the first and second battery cells are picked by the unloading orthogonal robot 400 and returned to the side of third and fourth battery cells (S209), the material is detected, is inspected whether there is any abnormality (S110), and when there is no abnormality, a reversal process ends.

On the other hand, when it is determined that battery cell sequences of a third set are required (S301), the loading orthogonal robot 300 picks second, third, and fourth battery cells of the third sequence (S303), and the cell support pad 230 of the cell reversing unit 200 ascends (S304). The first, second, and third battery cells are loaded on the cell support pad 230 (S305), the cell clamp chuck cylinder 240 picks the second, third, and fourth battery cells, and the cell support pad 230 descends (S306).

The second, third, and fourth battery cells reversed by rotating in the horizontal direction by the rotation of the cell clamp chuck cylinder 240, are reversed by rotating in the vertical direction by the rotation of the cell inversion rotary cylinder 250, and simultaneously, the cell reversing unit 200 moves by one pitch by the moving orthogonal robot 210 (S307). The cell support pad 230 ascends, and the cell clamp chuck cylinder 240 releases the picking of the second, third, and fourth battery cells to load the second, third, and fourth battery cells on the cell support pad 230 (S308).

Thereafter, the second, third, and fourth battery cells are picked by the unloading orthogonal robot 400 and returned to the side of the first battery cell (S309), the material is detected, is inspected whether there is any abnormality (S110), and when there is no abnormality, a reversal process ends.

As described above, according to an exemplary embodiment of the present disclosure, an installation area and an investment cost of a device may be reduced by integrating three existing battery cell reversal processes into one process.

Furthermore, when a problem occurs in a portion of a pitch conveyor due to a structure of the pitch conveyor, while the entire line needs to be stopped, management points may be reduced due to a process reduction.

Furthermore, a fully flexible facility that only requires an addition of a program is implemented without adding a separate instrument portion, and a multi-variety hybrid production is possible in one line.

Furthermore, the number of direct contacts with a battery cell is reduced, and thus, damage to the battery cell may be reduced, and a stable reversal is possible.

Furthermore, all projects may be deployed horizontally regardless of the type and size of a battery cell, and as a standardized facility in a battery cell assembly line, it is possible to reduce costs of specification review, design, and manufacturing.

In addition, the term related to a control device such as “controller”, “control apparatus”, “control unit”, “control device”, “control module”, “control circuit”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present invention. The control device according to exemplary embodiments of the present invention may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may process data according to a program provided from the memory, and may generate a control signal according to the processing result.

The control device may be at least one microprocessor operated by a predetermined program which may include a series of commands for carrying out the method disclosed in the aforementioned various exemplary embodiments of the present invention.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A battery cell reversal apparatus for reversing a plurality of battery cells forming an electrode assembly, the apparatus comprising:
a pitch conveyor on which the plurality of battery cells are accommodated and configured to extend in one direction and operate the plurality of battery cells to move;
a cell reversing unit configured to reverse a battery cell selected from the pitch conveyor;
a loading orthogonal robot configured to discharge the selected battery cell from the pitch conveyor to the cell reversing unit; and
an unloading orthogonal robot configured to return the battery cell on which reversal has been completed by the cell reversing unit to the pitch conveyor.

2. The battery cell reversal apparatus of claim 1, wherein the plurality of battery cells include four battery cells in a bundle.

3. The battery cell reversal apparatus of claim 1, further including a moving orthogonal robot,
wherein the cell reversing unit is configured to allow the battery cell on which the reversal has been completed to move one pitch by the moving orthogonal robot in a moving direction of the pitch conveyor.

4. The battery cell reversal apparatus of claim 3, further including a linear motion (LM) guide,
wherein the cell reversing unit is configured to move along the linear motion (LM) guide extending in a direction parallel to a longitudinal direction of the moving orthogonal robot.

5. The battery cell reversal apparatus of claim 1, wherein the cell reversing unit includes:
a cell support pad on which the plurality of battery cells discharged from the pitch conveyor are accommodated;
cell clamp chuck cylinders configured to clamp the plurality of battery cells at an upper portion of the cell support pad; and
cell reversing rotary cylinders configured to rotate to reverse the clamped battery cells.

6. The battery cell reversal apparatus of claim 5, further including a reciprocating cell support pad ascending and descending guide cylinder,
wherein the cell support pad is supported by the reciprocating cell support pad ascending and descending guide cylinder and operates to ascend or descend with respect to the cell clamp chuck cylinders.

7. The battery cell reversal apparatus of claim 6, wherein the cell support pad is configured to:
ascend by the cell support pad ascending and descending guide cylinder so that the battery cells discharged by the loading orthogonal robot is accommodated thereon, and
in response that the cell clamp chuck cylinder clamps the battery cells, descend again by the cell support pad ascending and descending guide cylinder.

8. The battery cell reversal apparatus of claim 5, wherein the cell support pad includes blocks divided into four zones, and the blocks include four battery cells to be respectively accommodated thereon.

9. The battery cell reversal apparatus of claim 8, wherein the cell clamp chuck cylinders are provided in four sets on an upper portion of the cell support pad to respectively correspond to the blocks.

10. The battery cell reversal apparatus of claim 9, wherein a set of cell clamp chuck cylinders is provided as a pair fixed to an inside of a cell clamp chuck cylinder fixing member and facing each other.

11. The battery cell reversal apparatus of claim 10, wherein the set of cell clamp chuck cylinders is configured to operate to clamp upper end portions and lower end portions of the battery cells and rotate together inside the cell clamp chuck cylinder fixing member to reverse the battery cells in a horizontal direction thereof.

12. The battery cell reversal apparatus of claim 11, wherein the cell reversing rotary cylinders are provided to face each other outside of the cell clamp chuck cylinder fixing member and operate to rotate while supporting the cell clamp chuck cylinder fixing member.

13. The battery cell reversal apparatus of claim 12, wherein the cell reversing rotary cylinders are configured to reverse the battery cells clamped on the cell clamp chuck cylinders in a vertical direction by rotating the cell clamp chuck cylinder fixing member.

14. The battery cell reversal apparatus of claim 1,
wherein the selected battery cell is reversed by the cell reversing unit and simultaneously moves one pitch in a longitudinal direction of the pitch conveyor, and
wherein the battery cell which is not selected moves one pitch on the pitch conveyor in the longitudinal direction of the pitch conveyor.

15. The battery cell reversal apparatus of claim 14, wherein the battery cell on which reversal has been completed by the cell reversing unit is returned to side of the battery cell which is not selected on the pitch conveyor by the unloading orthogonal robot and is aligned.
